(19) United States
(12) Patent Application Publication
(10) Pub. No.: US 2025/0344905 A1
(43) Pub. Date: Nov. 13, 2025

(54) APPARATUS FOR ADJUSTMENT OF BOWL HEIGHT FOR STAND MIXER

(71) Applicant: Zachary David Dinicola, Augusta, KS (US)

(72) Inventor: Zachary David Dinicola, Augusta, KS (US)

(21) Appl. No.: 19/201,607

(22) Filed: May 7, 2025

Related U.S. Application Data
(60) Provisional application No. 63/731,475, filed on May 7, 2024.

(51) Int. Cl. A47J 43/07; A47J 43/044; B01F 27/805; B01F 101/00

(52) U.S. Cl. CPC A47J 43/0705; A47J 43/044; A47J 43/0727; B01F 27/805; A47J 2043/04463; B01F 2101/1805

(57) ABSTRACT

Systems and methods are disclosed herein, including a height adjustment sleeve and an insert, which may be contemplated as a height adjustment kit. The height adjustment sleeve may have a first side with a first height and a second side with a second height, and a peripheral wall extending between them. An aperture within the peripheral wall may allow passage to a slot, where a stand mixer bowl tab may be accommodated. The slot may further accommodate the insert having a third thickness. The height adjustment sleeve and the insert may be positioned in various configurations for various bowl height adjustment based on a selection of one or more of the first height, the second height, and the third height being disposed below the stand mixer bowl tab.

### CROSS-REFERENCE TO RELATED APPLICATIONS

This application claims priority to the provisional patent application identified by U.S. Ser. No. 63/731,475, filed May 7, 2024, the entire content of which is hereby expressly incorporated herein by reference.

### BACKGROUND

All-purpose portable mixers, such as “hand mixers” and “stand mixers”, are devices that use a gear-driven mechanism to automate physical tasks like stirring, beating, whisking, and kneading. Originally developed in the twentieth century, the functionality and practicality of stand mixers have made them a present-day staple in both domestic and commercial settings. Traditional stand mixers incorporate a driving motor mounted in a frame or stand, which bears the weight of the device. Although varying in size, from floor models to counter top models, stand mixers traditionally include a frame-mounted drive motor and compatible bowl that is securable to the frame for mixing.

Stand mixer bowls, particularly counter top stand mixers, typically exhibit one of two designs for attaching and accessing the bowl. “Tilt-head” stand mixers generally support the bowl at the base of the mixer, utilizing a base-mount mechanism, like threading, for securing the bowl to the mixer. In contrast, “bowl-lift” or “bowl raise” stand mixers support the bowl from the column of the stand mixer, generally including an arm-like “bowl support.” The stand mixer bowl includes brackets or “bowl tabs” on the side of the bowl, which align with locating pins on the bowl support arms. The locating pins fit through the bowl tabs, putting the bowl in the proper position to be latched to the mixer column and utilized for mixing.

However, before operating the bowl-lift mixer the bowl must be raised, usually via a lever on the mixer column, to accommodate the agitator(s) (e.g., beater, dough hook, whisk/whip) attached to the beater shaft/mixer head. The distance between the bottom of the bowl interior and the agitator, or “beater-to-bowl clearance”, is thus subject to the factory-set limits and can be difficult to adjust. The correct beater-to-bowl clearance is necessary to achieve optimal mixing results. If the beater is too close to the bowl bottom it may scrape the bowl or completely prevent mixing; if too far from the bowl bottom it may not properly incorporate the bowl contents.

### SUMMARY

Accordingly, there is a need for improved bowl height adjustment mechanisms that remedy the design flaws of current stand mixers, allowing users to easily extend the height of the bowl. In addition to a need for easier adjustment, there is a need for bowl height adjustment apparatus that allow for adjustment beyond the factory-set limits. It is to such an apparatus and kit that the inventive concepts disclosed herein are directed.

The problem of inconvenient and unsatisfactory bowl height adjustment mechanisms is addressed through a height adjustment sleeve for selectably adjusting a bowl height for a stand mixer bowl. The height adjustment sleeve comprises a first side, a second side, a peripheral wall, and an aperture. The first side has a first thickness and comprises a first external surface, a first internal surface, and a first opening extending from the first external surface to the first internal surface. The second side has a second thickness and comprises a second external surface, a second internal surface, and a second opening extending from the second external surface and the second internal surface. The second thickness is greater than the first thickness. The peripheral wall extends between the first side and the second side. The peripheral wall has an interior wall surface and an exterior wall surface. The aperture is formed in the peripheral wall and extends between the interior wall surface and the exterior wall surface. The aperture is in communication with and allows passage to a slot within the height adjustment sleeve. The slot is defined by the first internal surface, the second internal surface, and the interior wall surface, and is dimensioned to accommodate at least a portion of a bowl tab. In some embodiments, the height adjustment sleeve further comprises an insert. The insert is dimensioned to fit within the height adjustment sleeve and engage at least one of a first interior surface, a second interior surface, and the interior wall surface of the height adjustment sleeve. The insert is substantially flat, having an insert thickness equal to or less than the second thickness. The insert further includes an insert opening such that when the insert is positioned within the slot of the height adjustment sleeve, the insert opening is substantially aligned with the first opening and the second opening.

Further disclosed herein is a height adjustment kit comprising a plurality of the height adjustment sleeves and (optionally) a plurality of inserts.

The foregoing Summary provides an overview of certain selected implementations or embodiments disclosed herein, and is not intended to describe every aspect, embodiment, implementation, feature, or advantage of the disclosure exhaustively or comprehensively. Therefore, this Summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

The details of one or more implementations of the subject matter of this specification are set forth in the accompanying drawings and the description below. Other aspects, features and advantages will become apparent from the description, the drawings, and the claims.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a perspective view of an exemplary height adjustment sleeve in accordance with the present disclosure, wherein the height adjustment sleeve is implemented for stand mixer operation;

FIG. 2 is a perspective view of an exemplary height adjustment sleeve in accordance with the present disclosure;

FIG. 3 is a side view of an exemplary height adjustment sleeve in accordance with the present disclosure;

FIG. 4 is a front perspective view of an exemplary insert in accordance with the present disclosure;

FIG. 5 is a side view of an exemplary height adjustment sleeve and insert in accordance with the present disclosure;

FIG. 6 is cross-sectional view of an exemplary height adjustment sleeve and insert implemented for bowl height adjustment in accordance with the present disclosure;

FIG. 7A is a perspective view of an exemplary embodiment of an agitator in accordance with the present disclosure, wherein the agitator is implemented as a flexible-edge beater;

FIG. 7B is a perspective view of an exemplary embodiment of an agitator in accordance with the present disclosure, wherein the agitator is implemented as a flat beater;

FIG. 7C is a perspective view of an exemplary embodiment of an agitator in accordance with the present disclosure, wherein the agitator is implemented as a wire whip;

FIG. 7D is a perspective view of an exemplary embodiment of an agitator in accordance with the present disclosure, wherein the agitator is implemented as a dough hook;

FIG. 7E is a perspective view of an exemplary embodiment of an agitator in accordance with the present disclosure, wherein the agitator is implemented as a pastry beater.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction, experiments, exemplary data, and/or the arrangement of the components set forth in the following description, or illustrated in the drawings. The presently disclosed and claimed inventive concepts are capable of other embodiments or of being practiced or carried out in various ways. Also, it is to be understood that the phraseology and terminology employed herein is for the purpose of description only and should not be regarded as limiting in any way.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

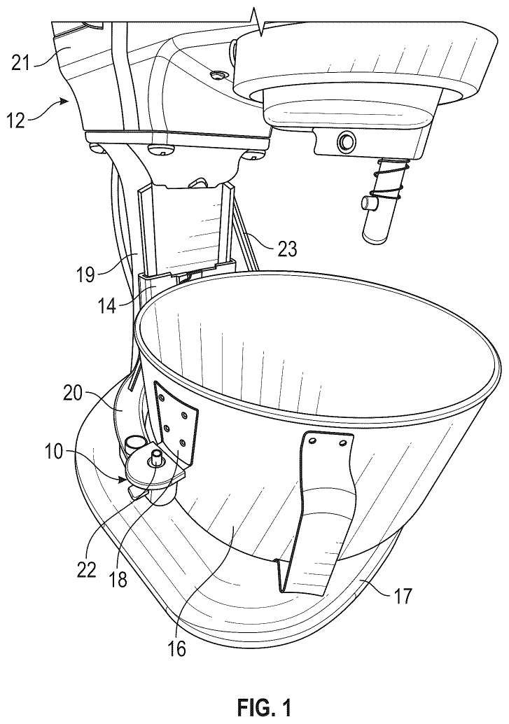

Referring now to the drawings, and in particular to FIG. 1, shown therein is a perspective view of an exemplary embodiment of a height adjustment sleeve 10 constructed in accordance with the present disclosure. The height adjustment sleeve 10 may include elements of a height adjustment kit related to stand mixers 12. Accordingly, the term “stand mixer,” as used herein, refers to a mixing appliance designed to stand on a surface, usually a counter top, a table, or a floor. For example, a stand mixer 12 may be a KitchenAid® Bowl-Lift Stand Mixer model KP26M1X (Whirlpool Corp., Benton Harbor, MI). The components of the stand mixer 12 referred to have been represented, where appropriate, by conventional symbols in the drawings, showing only those specific details that are pertinent to understanding the embodiments of the present disclosure.

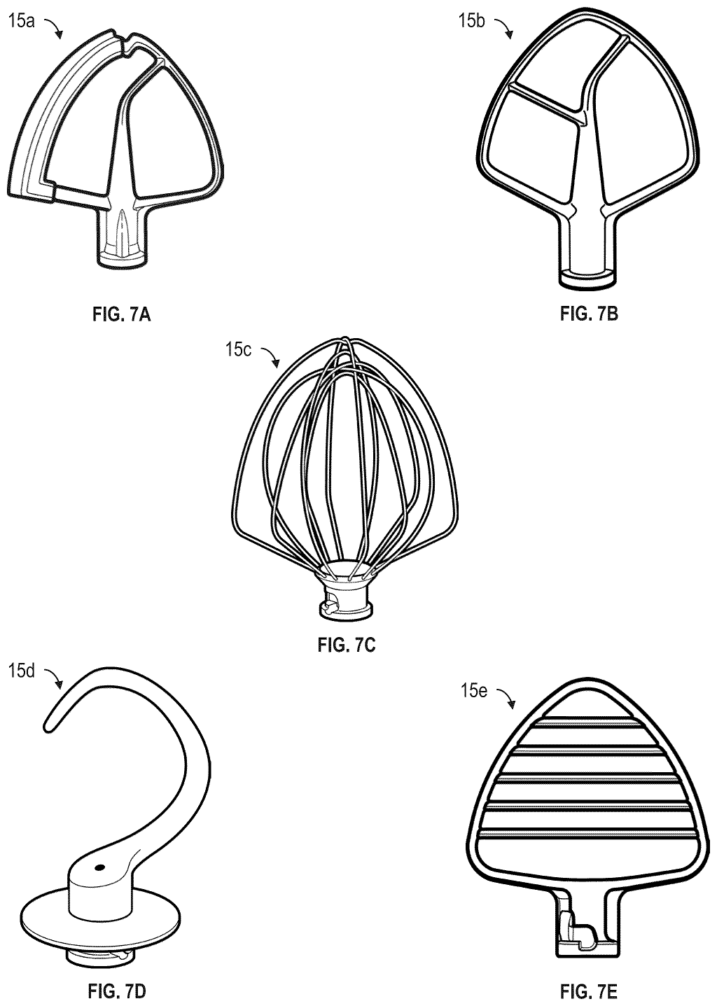

The term “height adjustment” 13 used herein refers to the altered distance between a stand mixer's bowl support 14 and a stand mixer bowl 16, particularly one or more bowl tab 18 that are fixed to an exterior of the stand mixer bowl 16. The terms “bowl height” or “beater-to-bowl clearance” used herein may also refer to the height adjustment 13, as the height adjustment 13 at the bowl support 14 also describes the accordingly altered distance between a bottom point of the stand mixer bowl 16 and an agitator 15 (e.g., a beater, dough hook, whip) (shown in FIGS. 7A-7E) attached to a beater shaft/mixer head of the stand mixer 12.

The stand mixer 12 is generally provided with a base 17, a column 19 extending from the base, and a head 21 attached to the column. The column of the stand mixer 12 includes the bowl support 14. The bowl support 14 is preferably configured so as to couple with the stand mixer bowl 16. The stand mixer bowl 16 may have one or more bowl tab 18 extending from the exterior body of the stand mixer bowl 16, the bowl tab 18 configured to engage the bowl support 14 of the stand mixer 12.

In the present disclosure it is contemplated that the bowl support 14 may include one or more support arm 20 having an arm pin 22 extending from the support arm 20, the arm pin 22 configured to engage the bowl tab 18 to properly orient the stand mixer bowl 16 for stand mixer use.

The column 19 of the stand mixer 12 may include other attachment features, such as a spring latch (not shown), to secure the stand mixer bowl 16 to the stand mixer 12. The stand mixer 12 may also be provided with a lift mechanism 23, such as a lever, to transition the stand mixer bowl 16 between an operating (i.e., raised) and non-operating (i.e., lowered) position.

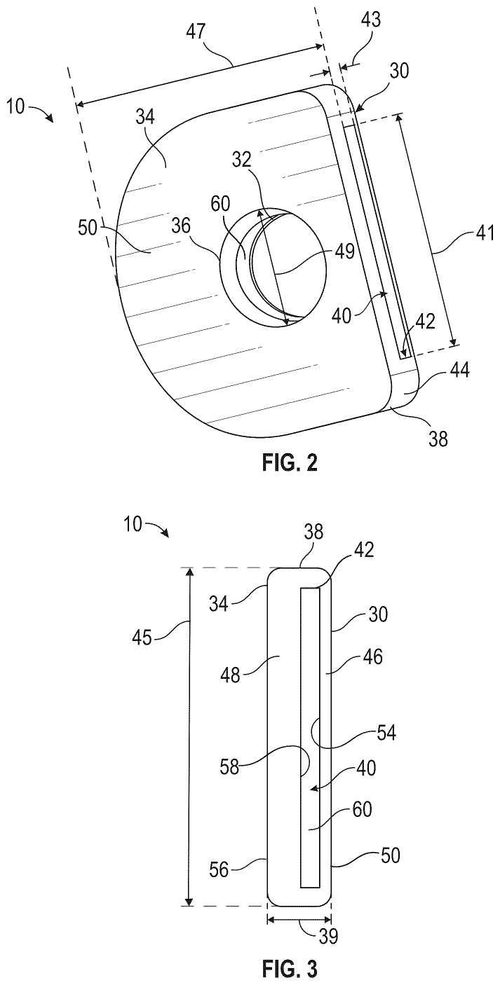

Referring now to FIG. 2, shown therein is a perspective view of an exemplary embodiment of the height adjustment sleeve 10 of FIG. 1 constructed in accordance with the present disclosure. The height adjustment sleeve 10 may be engageable with the bowl tab 18 of the stand mixer bowl 16 to allow for selectable height adjustment of the stand mixer bowl 16, e.g., for optimized stand mixer 12 operation.

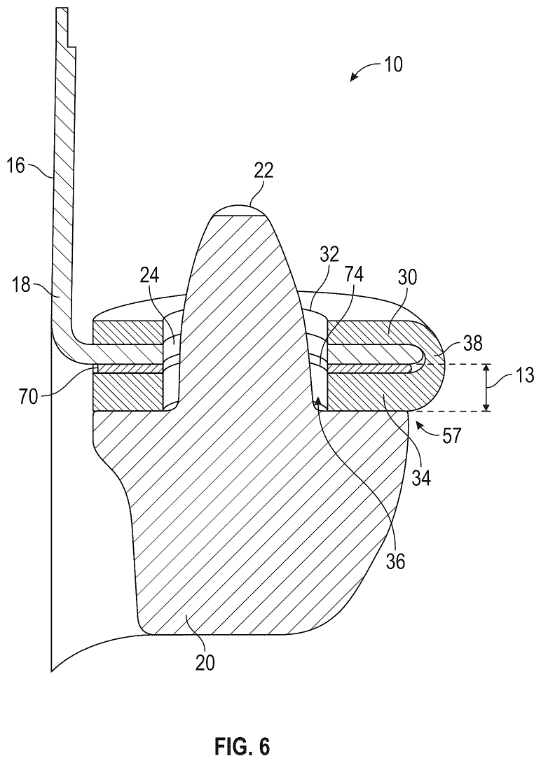

As it relates to the present disclosure, the arm pin 22 may be received by a tab hole 24 (shown in FIG. 6) within the bowl tab 18, the arm pin 22 being effective to engage the bowl tab 18, and thus the stand mixer bowl 16, with the stand mixer 12.

Broadly, the height adjustment sleeve 10 has a first side 30 with a first opening 32, a second side 34 with a second opening 36, a peripheral wall 38, and an aperture 40. The peripheral wall 38 extends between the first side 30 and the second side 34, and has an interior wall surface 42 and exterior wall surface 44. The aperture 40 is formed in the peripheral wall 38 and extends between the interior wall surface 42 and exterior wall surface 44.

In one aspect, the height adjustment sleeve 10 may have a sleeve length 45 and a sleeve width 47 that are sized to accommodate the bowl tab 18 without disrupting stand mixer 12 operation. The sleeve length 45 may be the distance between edges of the peripheral wall 38 of the height adjustment sleeve 10 (i.e., distance spanning across the aperture 40). In some implementations, the sleeve length 45 may be between 0.75 and 2 inches. In some implementations, the sleeve length 45 may be between 1.0 and 1.5 inches. In one exemplary embodiment, the sleeve length 45 is 1.307 inches. The sleeve width 47 may be the distance between the aperture 40 and a farthest point of the peripheral wall 38 that is substantially perpendicular to the aperture 40. In some implementations, the sleeve width 47 is between 0.6 and 1.75 inches. More specifically, in some implementations, the sleeve width 47 is between 0.75 and 1.25 inches. In one exemplary embodiment, the sleeve width 47 is 0.97 inches.

The aperture 40 of the height adjustment sleeve 10 is in communication with, and may allow passage to, a slot 60 within the height adjustment sleeve 10. The slot 60 may be defined by a first internal surface 54, a second internal surface 58, and the interior wall surface 42. The aperture 40 may have an aperture length 41 and an aperture width 43 that are dimensioned to be equal or greater than the corresponding dimensions of the bowl tab 18 that may be received by the slot 60. The aperture length 41, in particular, may be less than the sleeve length 45. As such, in some embodiments, the aperture length 41 may be between 0.75 and 1.4 inches. More specifically, in some embodiments, the aperture length 41 may be between 0.9 and 1.2 inches.

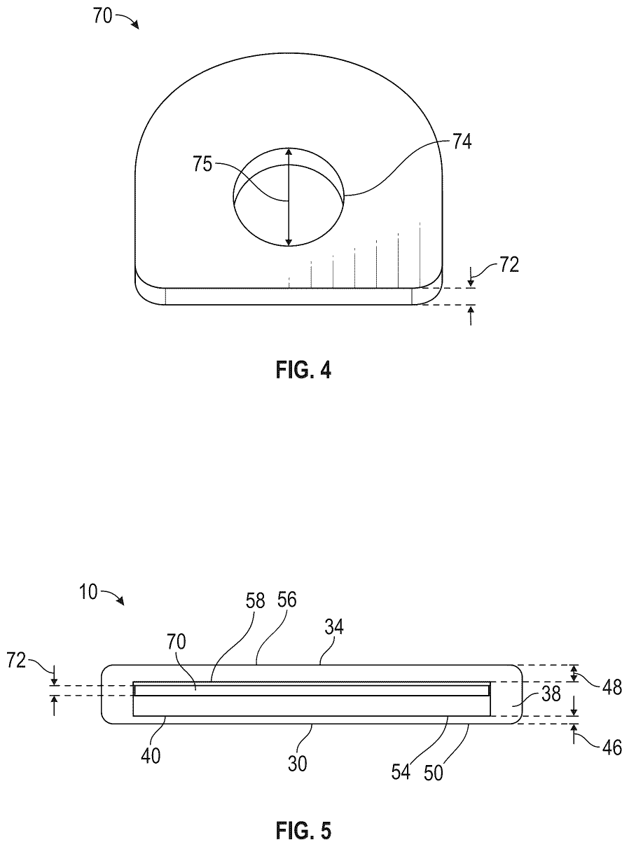

The aperture width 43 may be dimensioned to at least accommodate the bowl tab 18, but may also be dimensioned to accommodate further components, such as an insert 70 (shown in FIG. 4 and described in more detail below). In some embodiments, the aperture width 43 may be between 0.02 and 0.15 inches. More specifically, in some embodiments, the aperture width 43 may be between 0.06 and 0.12 inches. In one exemplary embodiment, the aperture width 43 may be 0.0935 inches.

The slot 60 may be dimensioned to accommodate at least a portion of the bowl tab 18 of the stand mixer bowl 16. In some implementations, the slot 60 may be further dimensioned to accommodate at least a portion of the bowl tab 18 and the insert 70 (shown in FIG. 4). Accordingly, the slot 60 may have a shape and/or form that reflects the shape and/or form of the height adjustment sleeve 10 generally. In other embodiments, however, the slot 60 may have a different shape than the height adjustment sleeve 10, the first side 30 and/or the second side 34.

As such, it is contemplated that the height adjustment sleeve 10 may be any shape suitable for engaging the bowl tab 18 without disrupting the functionality of the stand mixer 12. The height adjustment sleeve 10, particularly the first side 30 and second side 34, may be shaped to reflect the bowl tab 18, such that the height adjustment sleeve 10 is contoured to the general shape or form of the bowl tab 18. For example, in one embodiment, as illustrated in FIGS. 1 and 2, the height adjustment sleeve 10 may be a semi-oval shape. In other implementations, the height adjustment sleeve 10 may be quadrilateral, pentagonal, hexagonal, or any fanciful design. In other embodiments, the shape of the height adjustment sleeve 10 may not correspond with the shape of the bowl tab 18.

As illustrated in FIGS. 1 and 2, the first opening 32 and second opening 36 of the height adjustment sleeve 10 may be dimensioned for the passage therethrough of the arm pin 22 of the support arm 20. Accordingly, the first opening 32 and second opening 36 may be any shape and size suitable to receive the arm pin 22 and/or the support arm 20. The first opening 32 and second opening 36 may also be displaced anywhere within the first side 30 and second side 34, respectively, of the height adjustment sleeve 10. As exemplified in the embodiment of FIG. 2, the first opening 32 and second opening 36 may be substantially aligned with each other, the displacement of the first opening 32 within the first side 30 mirroring the displacement of the second opening 36 within the second side 34. In other embodiments, the first opening 32 and second opening 36 may not be substantially aligned with each other.

The first opening 32 and second opening 36 of the height adjustment sleeve 10 may have a same opening diameter 49. The opening diameter 49 may be any distance equal to or greater than a greatest diameter of the arm pin 22 of the bowl support 14. In some embodiments, the opening diameter 49 may be between 0.2 and 0.75 inches. In some embodiments, the opening diameter 49 may be between 0.3 and 0.5 inches. In an exemplary embodiment, the opening diameter 49 is 0.365 inches.

Now referring to FIG. 3 in particular, illustrating a side view of an exemplary embodiment of the height adjustment sleeve 10 disclosed herein, the second thickness 48 may be greater than the first thickness 46 of the height adjustment sleeve 10. The difference between the first thickness 46 and second thickness 48 may provide for height adjustment 13, as either a first external surface 50 or a second external surface 56 may engage the support arm 20, and thus provide a height adjustment 13 of the first thickness 46 or the second thickness 48. In some embodiments, the second thickness 48 may be between 1.5x and 2x the first thickness 46. For example, in one exemplary embodiment, the second thickness 48 may be 1.77x the first thickness 46, such that the second thickness 48 is 0.062 inches and the first thickness 46 is 0.035 inches.

The first side 30 and the second side 34 of the height adjustment sleeve 10 have a first thickness 46 and second thickness 48, respectively. The first thickness 46 extends between a first external surface 50 and a first internal surface 54. The first opening 32 spans the first thickness 46, extending from the first external surface 50 to the first internal surface 54. Likewise, the second thickness 48 extends between a second external surface 56 and a second internal surface 58. The second opening 36 spans the second thickness 48, extending from the second external surface 56 to the second internal surface 58.

The first thickness 46, the second thickness 48, and the aperture width 43, together, generally determine a total thickness 39, which may also represent a height of the peripheral wall 38. Accordingly, the total thickness 39 may be variably dimensioned to accommodate at least the bowl tab 18, and in further implementations, at least the bowl tab 18 and the insert 70 (shown in FIG. 4). The total thickness 39 may be between 0.1 and 0.4 inches. More specifically, in some embodiments, the total thickness 39 may be between 0.15 and 0.25 inches. In one exemplary embodiment, the total thickness 39 may be 0.187 inches.

Referring now to FIG. 4, shown therein is a perspective view of an exemplary embodiment of the insert 70 constructed in accordance with the present disclosure. The insert 70 is dimensioned to fit within the slot 60 of the height adjustment sleeve 10. The insert 70 may engage at least one of the first internal surface 54, the second internal surface 58, and the interior wall surface 42. The insert 70 may be substantially flat, having an insert thickness 72 that may be equal to or less than the second thickness 48. In some implementations, the insert thickness 72 may be equal to or less than the first thickness 46. Accordingly, the insert thickness 72 may be between 0.01 and 0.06 inches. In one exemplary embodiment, the insert thickness is 0.035 inches.

As shown in detail in FIG. 6 and described below, the insert 70 may have an insert opening 74 that is substantially aligned with the first opening 32 and second opening 36 of the height adjustment sleeve 10, such that when the insert 70 is positioned within the height adjustment sleeve 10, the arm pin 22 may pass through the first opening 32, the insert opening 74, and the second opening 36. Accordingly, the insert opening 74 may be dimensioned similarly to the first opening 32 and second opening 36.

In this aspect, the insert opening 74 may have an insert opening diameter 75 that is substantially similar or the same as the opening diameter 49. The insert opening diameter 75 may be any distance equal to or greater than a greatest diameter of the arm pin 22 of the bowl support 14. In some embodiments, the insert opening diameter 75 may be between 0.2 and 0.75 inches. In some embodiments, the insert opening diameter 75 may be between 0.3 and 0.5 inches. In an exemplary embodiment, the insert opening diameter 75 is 0.365 inches.

Turning to FIG. 5, shown therein is a side view of an exemplary embodiment of the height adjustment sleeve 10 with the insert 70 inserted in accordance with the present disclosure. The interior wall surface 42, and either the first internal surface 54 or second internal surface 58, may engage the insert 70 within the slot 60 of the height adjustment sleeve 10 to facilitate variable, customized height adjustment 13. In this aspect, the insert 70 may be fitted within the slot 60 before the bowl tab 18 is received within the slot 60. The insert 70 may be disposed, for example, above or below the bowl tab 18 within the slot 60, so as to provide additional height and/or support above or below the bowl tab 18.

In some implementations, the insert 70 positioned within the slot 60 may be one insert, as illustrated in FIG. 5. In other implementations, the insert 70 positioned within the slot 60 may be two or more inserts 70. In such embodiments, wherein the insert 70 is two or more inserts, the two or more inserts 70 may have the same insert thickness 72. In other such embodiments, wherein the insert 70 is two or more inserts 70, individual inserts may have different insert thicknesses 72, such that a first insert thickness is different from a second insert thickness.

The height adjustment sleeve 10 and the insert 70 may be fabricated via any suitable manufacturing/design method from any deformation-resistant material or combinations thereof. Materials may be any color, pattern, and/or texture, and may exhibit both rigid and non-rigid/elastic properties when solid. Accordingly, the height adjustment sleeve 10 and the insert 70 may be formed from a rubber, polymer, elastomer, epoxy, metal, composite, combinations thereof, and/or the like.

For example, in some implementations, the height adjustment sleeve 10 and the insert 70 may be formed from thermoplastic. In such embodiments, the height adjustment sleeve 10 and the insert 70 may be composed of nylon, acrylic, polycarbonate, polyethylene, polypropylene, and/or another thermoplastic polymer.

In some embodiments, the height adjustment sleeve 10 and the insert 70 may be formed from the same material. For example, in one implementation, the height adjustment sleeve 10 and the insert 70 may both be formed from silicone rubber. However, in other embodiments, the height adjustment sleeve 10 may be formed from a different material(s) than the insert 70. For example, in one implementation, the height adjustment sleeve 10 may be formed from synthetic rubber and the insert 70 may be formed from stainless steel.

Referring now to FIG. 6, shown therein is a perspective cross-sectional view of an exemplary height adjustment sleeve 10 engaging the insert 70 and the bowl tab 18 in accordance with the present disclosure. The height adjustment sleeve 10 and the insert 70 may be contemplated as a height adjustment kit for selectively adjusting the height of a stand mixer bowl. In use, the height adjustment kit may allow for easy, customized height adjustment 13 before and during stand mixer 12 operation. Accordingly, the height adjustment kit may be utilized to easily adjust height adjustment 13 specific to any number of agitators and/or stand mixer 12 accessories.

The height adjustment kit, including the height adjustment sleeve 10 and the insert 70, may present a variable number of height adjustment 13 options depending upon the dimensional characteristics and/or the quantity of the height adjustment sleeve 10 and the insert 70. For example, in one implementation, the height adjustment kit may include one height adjustment sleeve 10 and one insert 70. In other implementations, the height adjustment kit may include two height adjustment sleeve 10 and four insert 70. For example, in one embodiment, the height adjustment kit may be suited for use with a KitchenAid® Bowl-lift Stand Mixer (Whirlpool Corp., Benton Township, MI) and thus include two height adjustment sleeve 10, one for each bowl tab 18 of the KitchenAid® Stand Mixer bowl, and two inserts 70. Accordingly, the exemplary height adjustment kit of such an embodiment may allow for at least four distinct height adjustments 13 given the first thickness 46 of the first side 30, second thickness 48 of the second side 34, and insert thickness 72 of the insert 70 allow for multiple variations in height adjustment 13 depending upon the configuration chosen.

Now, although continuing to referencing the Figures to illustrate various height adjustment kit configurations, it is understood that the height adjustment sleeve 10 and the insert 70 may be configured to create any number of height adjustments 13. The scope of the present inventive concepts is not to be limited in any manner by the following contemplated configurations/illustrations of use.

The height adjustment sleeve 10, configured as shown in FIG. 2 without the insert 70, presents at least three different height adjustment configurations alone.

In this aspect, a first sleeve position (not shown) may exist where the first external surface 50 engages the support arm 20. Similarly, a second sleeve position 57, shown in FIG. 6, may exist where the second external surface 56 engages the support arm 20. To illustrate, in the first sleeve position the bowl tab 18 (and thus the stand mixer bowl 16) may facilitate the height adjustment 13 generally equal to the first thickness 46. Similarly, in the second sleeve position 57, the mixer bowl 16 may have a height adjustment 13 generally equal to the second thickness 48. Thus, in switching the external surface of the height adjustment sleeve 10 that is engaging the support arm 20 (i.e., “flipping” the height adjustment sleeve 10), the height adjustment 13 may be customized and easily altered based upon changes to the height adjustment sleeve 10 configuration.

Although the above-described first sleeve position and second sleeve position 57 contemplate the height adjustment sleeve 10 in typical use, with the bowl tab 18 engaging the slot 60, the height adjustment sleeve 10 may also be configured to create height adjustment 13 without the bowl tab 18 engaging the aperture 40 and/or slot 60. For example, the height adjustment sleeve 10 may be oriented such that the first external surface 50 or second external surface 56 engage both the support arm 20 and the bowl tab 18. In other words, the height adjustment sleeve 10 is disposed between the support arm 20 and the bowl tab 18 (e.g., underneath the bowl tab 18). In this way, the height adjustment sleeve 10 may be positioned above or below the bowl tab 18. In one such embodiment, the height adjustment 13 may be an amount equal to total thickness 39 of the height adjustment sleeve 10.

The height adjustment sleeve 10, used in combination with the insert 70 as shown in FIGS. 5 and 6, presents numerous additional configurations for height adjustment 13. In this aspect, the height adjustment 13 may depend upon the number of insert 70 fitted within the slot 60 and the insert thickness 72 of the inserts 70.

Particularly, a user may dispose the insert 70 within the slot 60, and engage the bowl tab 18 within the slot 60 of the height adjustment sleeve 10 such that the insert 70 is underneath the bowl tab 18, to provide further fine adjustment to the height adjustment 13 based on the insert thickness 72 (in addition to the first thickness 46 or second thickness 48). For example, in one contemplated configuration, as illustrated in FIG. 6, the height adjustment 13 of the stand mixer bowl 16 may be equal to the insert thickness 72 plus the second thickness 48.

In other contemplated configurations, where the insert 70 is two or more inserts 70, the adjusted height adjustment 13 may be various multiples of insert thickness 72 in addition to the first thickness 46 or second thickness 48 of the height adjustment sleeve 10. As discussed above, two or more inserts 70 may each have the same insert thickness 72 or an insert thickness 72 that is different from at least one other insert 70. For example, in some configurations, the height adjustment 13 may be adjustably raised an amount equal to a first insert thickness 72 plus a second insert thickness 72 plus the first thickness 46 or second thickness 48. In such implementations, the first insert thickness 72 and second insert thickness 72 may be the same or different.

Notably, the insert 70, alone or in combination with another insert 70, may also be configured (within the slot 60 of the height adjustment sleeve 10) in relation to the bowl tab 18 such that the insert 70 is above the bowl tab 18, in a position where the insert thickness 72 may not necessarily contribute to the adjusted height adjustment 13. In such configurations, the insert 70 may provide stability for the height adjustment sleeve 10 by simply decreasing the slot 60 area. This may contribute to a snug, more secure fit for the bowl tab 18 within the remaining slot 60.

Similarly, in other embodiments where the bowl tab 18 is not engaged within the slot 60, but rather oriented upon the first external surface 50 or second external surface 56, the insert 70 may be placed within the slot 60 to provide additional stabilizing insert thickness 72. In such embodiments, the insert 70, alone within the slot 60 (without the bowl tab 18), may fill the slot 60 and thus provide support to the height adjustment sleeve 10 that prevents potential damage caused by compression from weight of the stand mixer bowl 16 and its contents. In other words, such configurations may be used to prevent the first internal surface 54 and/or second internal surface 58 from coming into contact, which may put unnecessary strain on the height adjustment sleeve 10.

Referring now to FIGS. 7A-7E, in certain embodiments, the agitator 15 may be implemented as one of a flexible edge beater 15a (shown in FIG. 7A), a flat beater 15b (shown in FIG. 7B), a wire whip 15c (also referred to as a “whisk”) (shown in FIG. 7C), a dough hook 15d (shown in FIG. 7D) and a pastry beater 15e (shown in FIG. 7E), for example.

In some embodiments, the agitator 15 may be at least partially formed from a thermoplastic elastomer material. In at least one such embodiment, the mixing implement 156 may be further provided with an enamel coating.

### CONCLUSION

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A height adjustment sleeve for selectably adjusting a bowl height for a stand mixer bowl, the height adjustment sleeve comprising:
a first side having a first thickness and comprising a first external surface, a first internal surface, and a first opening extending from the first external surface to the first internal surface;
a second side having a second thickness and comprising a second external surface, a second internal surface, and a second opening extending from the second external surface and the second internal surface, the second thickness being greater than the first thickness;
a peripheral wall extending between the first side and the second side, the peripheral wall having an interior wall surface and an exterior wall surface; and
an aperture formed in the peripheral wall and extending between the interior wall surface and the exterior wall surface, the aperture in communication with and allowing passage to a slot within the height adjustment sleeve, the slot defined by the first internal surface, second internal surface, and interior wall surface, dimensioned to accommodate at least a portion of a bowl tab.

2. The height adjustment sleeve of claim 1, further comprising:
an insert dimensioned to fit within the height adjustment sleeve, the insert engaging at least one of a first interior surface, a second interior surface, and the interior wall surface; and
wherein the insert is substantially flat, having an insert thickness equal to or less than the second thickness, and has an insert opening such that when the insert is positioned within the slot of the height adjustment sleeve, the insert opening is substantially aligned with the first opening and the second opening.

3. The height adjustment sleeve of claim 1, wherein the first opening and the second opening are configured to receive a pin from a stand mixer arm.

4. The height adjustment sleeve of claim 1, wherein the height adjustment sleeve is transitionable between a first position in which the first side engages a stand mixer arm surface and a second position in which the second side engages the stand mixer arm surface.

5. The height adjustment sleeve of claim 1, wherein the first side and the second side of the height adjustment sleeve are semi-oval shaped.

6. The height adjustment sleeve of claim 2, wherein the insert, the first side, and the second side all have the same shape.

7. The height adjustment sleeve of claim 6, wherein the insert, the first side, and the second side of the height adjustment sleeve are semi-oval shaped.

8. The height adjustment sleeve of claim 2, wherein the insert further comprises a first insert and a second insert, the first insert having a first insert thickness and the second insert having a second insert thickness.

9. The height adjustment sleeve of claim 8, wherein the first insert thickness and second insert thickness are the same.

10. The height adjustment sleeve of claim 2, wherein the insert is two or more insert.

11. A height adjustment kit for selectively adjusting a bowl height of a stand mixer bowl, the height adjustment kit comprising:
a height adjustment sleeve, the height adjustment sleeve comprising:
a first side having a first thickness and comprising a first external surface, a first internal surface, and a first opening extending from the first external surface to the first internal surface;
a second side having a second thickness and comprising a second external surface, a second internal surface, and a second opening extending from the second external surface and the second internal surface, the second thickness being greater than the first thickness;
a peripheral wall extending between the first side and the second side, the peripheral wall having an interior wall surface and an exterior wall surface; and
an aperture formed in the peripheral wall and extending between the interior wall surface and the exterior wall surface, the aperture in communication with and allowing passage to a slot within the height adjustment sleeve, the slot defined by the first internal surface, second internal surface, and interior wall surface, dimensioned to accommodate at least a portion of a bowl tab; and
an insert dimensioned to fit within the slot of the height adjustment sleeve, the insert engaging at least one of a first interior surface, a second interior surface, and the interior wall surface; and
wherein the insert is substantially flat, having an insert thickness equal to or less than the second thickness, and having an insert opening such that when the insert is positioned within the slot of the height adjustment sleeve, the insert opening is substantially aligned with the first opening and the second opening.

12. The height adjustment kit of claim 11, further comprising a bowl of a stand mixer.

13. The height adjustment kit of claim 11, wherein the insert further comprises a first insert and a second insert, the first insert having a first insert thickness, and the second insert having a second insert thickness.

14. The height adjustment kit of claim 13, wherein the first insert thickness and second insert thickness are the same.

15. The height adjustment kit of claim 11, wherein the insert is two or more inserts.

16. The height adjustment kit of claim 11, wherein the height adjustment sleeve is two or more height adjustment sleeves.

17. The height adjustment kit of claim 16, wherein the insert is two or more inserts.
